(19) United States
(12) Patent Application Publication
(10) Pub. No.: US 2025/0299622 A1
(43) Pub. Date: Sep. 25, 2025

(54) DISPLAY DEVICE, METHOD OF DRIVING THE SAME, AND ELECTRONIC DEVICE

(71) Applicant: Samsung Display Co., Ltd., Yongin-Si (KR)

(72) Inventors: Kuk Hwan AHN, Yongin-si (KR); Seung Jae LEE, Yongin-si (KR); Dae Gwang JANG, Yongin-si (KR); Seong Heon CHO, Yongin-si (KR)

(21) Appl. No.: 18/914,290

(22) Filed: Oct. 14, 2024

(30) Foreign Application Priority Data
Mar. 21, 2024 (KR) 10-2024-0039116

(51) Int. Cl. G09G 3/32

(52) U.S. Cl. CPC G09G 3/32; G09G 2300/0452; G09G 2300/0842; G09G 2310/027; G09G 2310/08; G09G 2320/0285; G09G 2320/041; G09G 2360/16

(57) ABSTRACT

According to embodiments of the disclosure, a display device includes a display unit including pixels connected to data lines and scan lines and including a plurality of blocks partitioned to include at least two or more of the pixels, at least one driver for driving the display unit, and a temperature determiner for predicting a temperature of the display unit in a unit of the blocks, the blocks include a first block including first sub-blocks positioned adjacent to the driver, and a second block including second sub-blocks positioned spaced apart from the driver, and an area of each of the first sub-blocks and an area of each of the second sub-blocks are different.

This application claims priority to Korean Patent Application No. 10-2024-0039116, filed on Mar. 21, 2024, and all the benefits accruing therefrom under 35 U.S.C. § 119, the content of which in its entirety is herein incorporated by reference.

### BACKGROUND

### 1. Field

The disclosure relates to a display device, a method of driving the same, and an electronic device.

### 2. Description of the Related Art

A display device includes a timing controller, a data driver, a display unit, and the like, and the display unit includes one or more pixels. The pixels may display a predetermined image, and the timing controller and the data driver may be a driver for controlling the pixels.

The driver may be positioned adjacent to or overlap the display unit, and a temperature of a partial area of the display unit positioned adjacent to the driver may be higher than that of another area. That is, a temperature of the display unit may be set differently in correspondence with a position of the driver, and thus a method of minimizing a temperature error when determining the temperature of the display unit is required.

### SUMMARY

A feature of the disclosure is to provide a display device, a method of driving the same, and an electronic device that minimize a temperature error in a display unit around a driver.

A feature of the disclosure is to provide a display device, a method of driving the same, and an electronic device that may improve display quality by minimizing a temperature error in a display unit.

According to embodiments of the disclosure, a display device includes a display unit including pixels connected to data lines and scan lines and including a plurality of blocks partitioned to include at least two or more of the pixels, at least one driver for driving the display unit, and a temperature determiner for predicting a temperature of the display unit in a unit of the blocks. The blocks include a first block including first sub-blocks positioned adjacent to the driver, and a second block including second sub-blocks positioned spaced apart from the driver. An area of each of the first sub-blocks and an area of each of the second sub-blocks are different.

According to an embodiment, the area of each of the first sub-blocks is less than the area of each of the second sub-blocks.

According to an embodiment, the area of the first sub-blocks gradually increases as a distance from the driver increases.

According to an embodiment, the display unit is divided in a plurality of horizontal lines and a plurality of vertical lines in correspondence with a disposition of the first sub-blocks and the second sub-blocks.

According to an embodiment, an area of the first sub-blocks positioned in a same horizontal line or a same vertical line has a same area.

According to an embodiment, the area of the first sub-block gradually increases as a distance from the driver increases.

According to an embodiment, the driver is disposed above or under the display unit, and the first sub-blocks are positioned in at least one horizontal line adjacent to the driver.

According to an embodiment, the driver is disposed on a left side or a right side of the display unit, and the first sub-blocks are positioned in at least one vertical line adjacent to the driver.

According to an embodiment, the driver overlaps the display unit, and the first sub-blocks are positioned at an intersection of at least one horizontal line and at least one vertical line overlapping the driver.

According to an embodiment, the plurality of first sub-blocks are positioned adjacent to the driver, and the area of the first sub-blocks is the same.

According to an embodiment, the plurality of first sub-blocks are positioned adjacent to the driver, and the area of the first sub-blocks gradually increases as a distance from the driver increases.

According to an embodiment, the display device may further include at least one data integrated circuit for driving the data lines, a scan driver for driving the scan lines, and a timing controller that controls the data integrated circuit and the scan driver, and includes the temperature determiner.

According to an embodiment, the driver includes at least one of the data integrated circuit, the scan driver, and the timing controller.

According to an embodiment, the temperature determiner includes a temperature calculator for generating a temperature value by calculating a temperature of the first sub-blocks and the second sub-blocks included in the display unit in response to a temperature prediction value of the driver, and a memory for providing position information and area information of the first sub-blocks and the second sub-blocks to the temperature calculator.

According to an embodiment, the temperature determiner further includes a voltage determiner for generating voltage data including voltage information corresponding to a grayscale of input data, and a temperature predictor for generating the temperature prediction value using the voltage data.

According to an embodiment of the disclosure, a method of driving a display device includes dividing a display unit into a plurality of blocks to determine a temperature of the display unit, determining a temperature of the blocks in response to input data, and displaying an image corresponding to the input data on the display unit using at least one driver. The blocks include at least one first sub-block positioned adjacent to the driver and at least one second sub-block positioned spaced apart from the driver, and an area of the first sub-block and an area of the second sub-block are different.

According to an embodiment, the area of the first sub-block is less than the area of the second sub-block.

According to an embodiment, the blocks include a plurality of first sub-blocks, and the area of the first sub-blocks gradually increases as a distance from the driver increases.

According to an embodiment of the disclosure, an electronic device includes a display module including a display panel for displaying an image and at least one driver for driving the display panel, and a processor for controlling the display module. The display panel is divided into a plurality of blocks to determine a temperature, and an area of a first sub-block of the blocks positioned adjacent to the driver is different from an area of a second sub-block of the blocks positioned spaced apart from the driver.

According to an embodiment, the area of the first sub-block is less than the area of the second sub-block.

Features of the disclosure are not limited to the features described above, and other technical features which are not described will be clearly understood by those skilled in the art from the following description.

In accordance with a display device, a method of driving the same, and an electronic device according to embodiments of the disclosure, the area of blocks adjacent to a driver may be set to be less than the area of blocks spaced apart from the driver, and a temperature of a display unit may be determined in a unit of blocks. In this case, even though the temperature of the driver is increased, the temperature of an area around the driver may be detected more accurately, and thus display quality may be improved.

However, an effect of the disclosure is not limited to the above-described effect, and may be variously extended within a range that does not deviate from the spirit and scope of the disclosure.

### BRIEF DESCRIPTION OF THE DRAWINGS

The above and other features of the disclosure will become more apparent by describing in further detail embodiments thereof with reference to the accompanying drawings.

FIGS. 1 and 2 are diagrams illustrating a display device according to an embodiment of the disclosure.

FIG. 3 is a block diagram illustrating a temperature determiner according to an embodiment of the disclosure.

FIG. 4 is a diagram illustrating an embodiment of blocks included in a display unit.

FIG. 5 is a block diagram illustrating a temperature determiner according to an embodiment of the disclosure.

FIG. 6 is a box plot illustrating a temperature dispersion in a first horizontal line.

FIG. 7 is a box plot illustrating an error temperature between a temperature value generated in the temperature determiner and an actually measured temperature value.

FIGS. 8A and 8B are diagrams illustrating an embodiment of the blocks included in the display unit.

FIGS. 9A and 9B are box plots illustrating the error temperature between the temperature value generated in the temperature determiner and the actually measured temperature value when displaying a first image.

FIGS. 10A and 10B are box plots illustrating the error temperature between the temperature value generated in the temperature determiner and the actually measured temperature value when displaying a second image.

FIGS. 11A and 11B are diagrams illustrating an embodiment of the blocks included in the display unit.

FIG. 12 is a diagram illustrating an embodiment of the blocks included in the display unit.

FIG. 13 is a diagram illustrating an embodiment of the blocks included in the display unit.

FIG. 14 is a diagram illustrating an embodiment of the blocks included in the display unit.

FIG. 15 is a diagram illustrating an embodiment of a pixel shown in FIG. 2.

FIG. 16 is a diagram illustrating an exemplary method of driving the pixel of FIG. 15.

FIG. 17 is a diagram illustrating an electronic device according to an embodiment of the disclosure.

### DETAILED DESCRIPTION OF THE EMBODIMENT

Hereinafter, various embodiments of the disclosure will be described in detail with reference to the accompanying drawings so that those skilled in the art may easily carry out the disclosure. The disclosure may be implemented in various different forms and is not limited to the embodiments described herein.

In order to clearly describe the disclosure, parts that are not related to the description are omitted, and the same or similar elements are denoted by the same reference numerals throughout the specification. Therefore, the above-described reference numerals may be used in other drawings.

In addition, since a size and a thickness of each configuration shown in the drawings are arbitrarily shown for convenience of description, the disclosure is not necessarily limited to that shown in the drawings. In order to clearly express multiple layers and areas in the drawing, a thickness may be exaggerated.

In addition, an expression “is the same” in the description may mean “is substantially the same”. That is, the expression “is the same” may be the same enough for those of ordinary skill to understand that it is the same. Other expressions may also be expressions in which “substantially” is omitted.

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the inventive concept. In addition, in some embodiments, the block, unit and/or module may be physically combined into more complex blocks, units, and/or modules without departing from the scope of the inventive concept.

A term “connection” between two configurations may mean that both of an electrical connection and a physical connection are used inclusively, but is not limited thereto. For example, “connection” used based on a circuit diagram may mean an electrical connection, and “connection” used based on a cross-sectional view and a plan view may mean a physical connection.

Although a first, a second, and the like are used to describe various components, these components are not limited by these terms. These terms are used only to distinguish one component from another component. Therefore, a first component described below may be a second component within the technical spirit of the disclosure. The singular expression includes the plural expression unless the context clearly dictates otherwise.

The disclosure is not limited to the embodiments disclosed below, and may be modified in various forms and may be implemented. In addition, each of the embodiments disclosed below may be implemented alone or in combination with at least one of other embodiments.

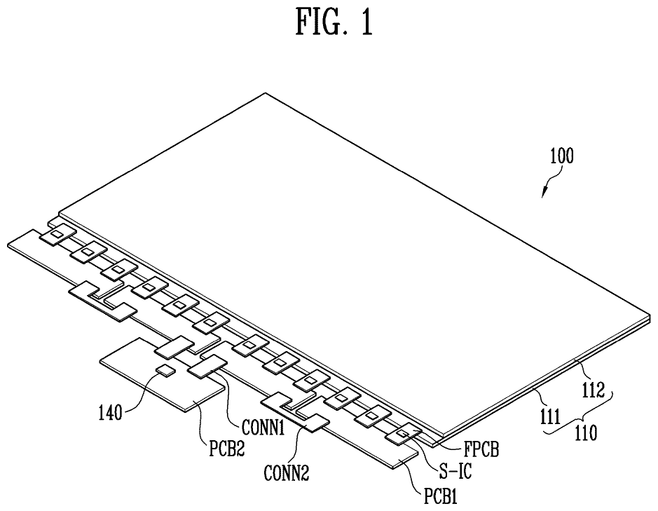

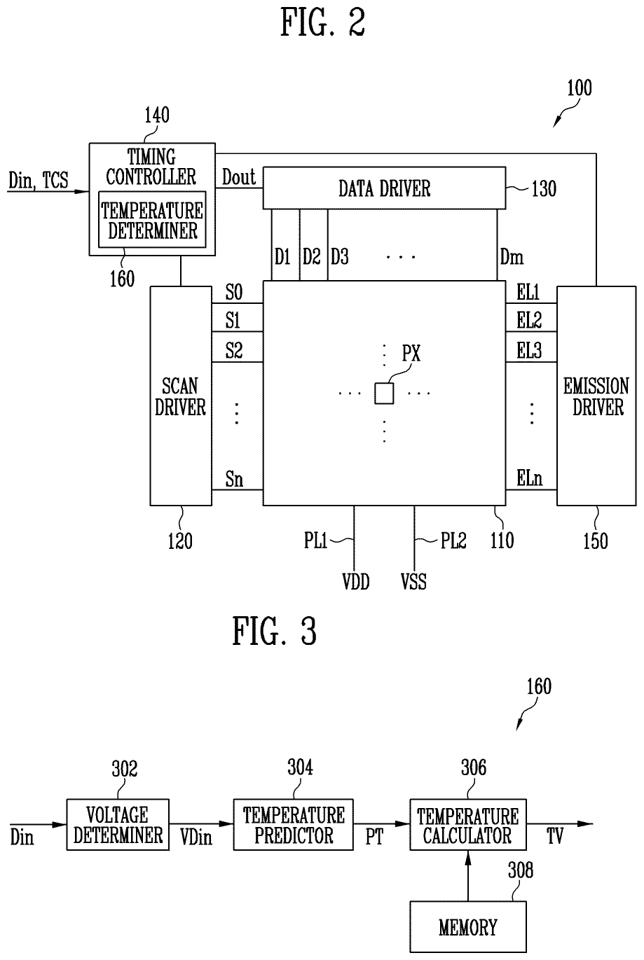

FIGS. 1 and 2 are diagrams illustrating a display device 100 according to an embodiment of the disclosure. FIG. 1 shows a perspective view of the display device 100, and FIG. 2 shows a block diagram of the display device 100.

Referring to FIGS. 1 and 2, the display device 100 according to an embodiment of the disclosure may include a display unit 110 (or a display panel), a scan driver 120, a data driver 130, a timing controller 140, and an emission driver 150. The scan driver 120, the data driver 130, the timing controller 140, and the emission driver 150 may configure a driving device (or a driver) that drives the display unit 110.

The display unit 110 may display an image. The display unit 110 may be an organic light emitting display panel, a liquid crystal display panel, an electrophoretic display panel, or an inorganic light emitting display panel.

As shown in FIG. 1, the display unit 110 may include a lower substrate 111 and an upper substrate 112. The lower substrate 111 may be a thin film transistor substrate formed of plastic or glass. The upper substrate 112 may be an encapsulation substrate formed of a plastic film, an organic substrate, or a protective film.

The display unit 110 may include scan lines S0, S1, S2, . . . , and Sn, data lines D1, D2, D3, . . . , and Dm, emission control lines EL1, EL2, EL3, . . . , and ELn, a first power line PL1, a second power line PL2, and pixels PX (here, each of n and m is a natural number equal to or greater than 4).

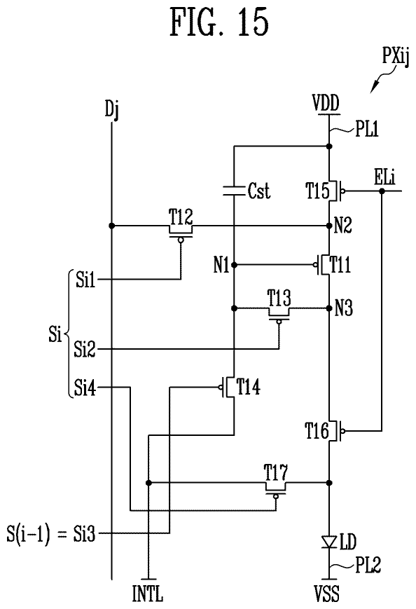

The pixels PX may be disposed in an area partitioned by the scan lines S0 to Sn, the data lines D1 to Dm, and the emission control lines EL1 to ELn. Each of the pixels PX may be connected to at least one of the scan lines S0 to Sn, one of the data lines D1 to Dm, and at least one of the emission control lines EL1 to ELn. For example, a pixel PXij (refer to FIG. 15) positioned in an i-th row and a j-th column may be connected to an i-th scan line Si, an i-th emission control line ELi, and a j-th data line Dj. Here, i is a natural number equal to or less than n, and j is a natural number equal to or less than m.

In addition, each of the pixels PX may be electrically connected between the first power line PL1 and the second power line PL2. A voltage of a first driving power VDD may be applied to the first power line PL1, and a voltage of a second driving power VSS may be applied to the second power line PL2. The first driving power VDD and the second driving power VSS may be a power voltage or a driving voltage required for an operation of the pixels PX, and the first driving power VDD may have a voltage level higher than that of the second driving power VSS.

Each of the pixels PX may receive a data signal from a data line connected thereto when a scan signal is supplied to a scan line connected thereto. A pixel receiving the data signal may emit light of a luminance corresponding to the data signal to an outside. Each of the pixels PX may emit one of a first color, a second color, or a third color to the outside. The first color, the second color, and the third color may be different colors. For example, the first color may be set to red, the second color may be set to green, and the third color may be set to blue. In an embodiment, the first color may be set to magenta, the second color may be set to cyan, and the third color may be set to yellow.

Additionally, signal lines (for example, the scan line, the data line, and the emission control line) and power lines connected to each of the pixels PX, and a driving method may be changed in accordance with a structure of the pixel. For example, the emission control line may be removed in accordance with the structure of the pixel. In an embodiment of the disclosure, the pixel may be selected as one of various currently known pixels.

The scan driver 120 may generate a scan signal in response to a control signal from the timing controller 140 and supply the scan signal to the scan lines SO to Sn. For example, the timing controller 140 may supply the control signal such as a scan start pulse and a clock signal to the scan driver 120. The scan driver 120 may be implemented as a shift register that sequentially generates and outputs the scan signal of a pulse form by sequentially shifting the scan start pulse of a pulse form using the clock signal.

The scan driver 120 may be formed together with the pixels PX on the display unit 110. However, the disclosure is not limited thereto, and for example, the scan driver 120 may be mounted on a circuit film and connected to the timing controller 140 via at least one circuit film and a printed circuit board.

The emission driver 150 may generate an emission control signal in response to a control signal from the timing controller 140 and supply the emission control signal to the emission control lines EL1 to ELn.

For example, the timing controller 140 may supply the control signal such as an emission start pulse and a clock signal to the emission driver 150. The emission driver 150 may be implemented as a shift register that sequentially generates and outputs the emission control signal of a pulse form by sequentially shifting the emission start pulses of a pulse form using the clock signal.

The emission driver 150 may be formed together with the pixels PX on the display unit 110. However, the disclosure is not limited thereto, and for example, the emission driver 150 may be mounted on a circuit film and connected to the timing controller 140 via at least one circuit film and a printed circuit board.

The data driver 130 may receive output data Dout and control signals from the timing controller 140. The data driver 130 receiving the control signals may generate an analog data signal (or data voltage) using digital output data Dout and supply the data signal to the data lines D1 to Dm. The data driver 130 may supply the data signal a pixel row (or horizontal line) unit. Here, the pixel row may refer to a row in which pixels connected to the same scan line are disposed.

The timing controller 140 may receive input data Din and a timing control signal TCS transmitted from an external system (for example, an application processor or the like) and generate the control signal to be supplied to the scan driver 120, the data driver 130, and the emission driver 150, based on the timing control signal TCS.

In addition, the timing controller 140 may determine a temperature of the display unit 110 in response to the input data Din. To this end, the timing controller 140 may include a temperature determiner 160. However, an embodiment of the disclosure is not limited thereto, and the temperature determiner 160 may be a configuration (e.g., such as an integrated circuit (IC) or the like) separated from the timing controller 140, and may be positioned outside the timing controller 140.

The temperature determiner 160 may determine the temperature of the display unit 110 in response to a load or the like of input data Din, and supply a determined temperature value to the timing controller 140. For example, the temperature determiner 160 may predict a temperature of at least one driver (for example, the timing controller 140, the data driver 130, the scan driver 120, and the emission driver 150) in response to the load of the input data Din, and determine the temperature of the display unit 110 in response to the predicted temperature.

For example, the timing controller 140 may convert the input data Din to generate the output data Dout. For example, the timing controller 140 may correct the input data Din in response to a temperature value of the display unit 110 determined in the temperature determiner 160 to generate the output data Dout. In an embodiment, the temperature value of the display unit 110 determined in the temperature determiner 160 may be used in various currently known driving methods.

As shown in FIG. 1, the data driver 130 may include a plurality of data integrated circuits S-IC (or source integrated circuits S-IC). The data integrated circuits S-IC may be mounted on a flexible circuit board FPCB and connected to the timing controller 140 via at least one printed circuit board PCB1 and PCB2 and/or at least one cable CONN1 and CONN2.

In an embodiment, the data integrated circuit S-IC may be mounted on the flexible printed circuit board FPCB, and one side of the flexible printed circuit board FPCB may be electrically connected to pads (not shown) positioned on the display unit 110. Here, the pads may be electrically connected to the data lines D1 to Dm, and thus the data integrated circuit S-IC may be electrically connected to the data lines D1 to Dm.

The timing controller 140 may be mounted on the second printed circuit board PCB2. The second printed circuit board PCB2 may be electrically connected to the first printed circuit board PCB1 via the first cables CONN1. In addition, each of the first printed circuit boards PCB1 may be electrically connected via the second cables CONN2. In this case, the timing controller 140 may be electrically connected to the data integrated circuit S-IC via the first printed circuit board PCB1, the first cables CONN1, and the second cables CONN2.

Although FIG. 1 shows that only the timing controller 140 is mounted on the second printed circuit board PCB2, an embodiment of the disclosure is not limited thereto. For example, various configurations including a sensing unit, a power supply, and the like may be additionally mounted on the second printed circuit board PCB2. In addition, an application processor may be additionally mounted on the second printed circuit board PCB2. For example, the application processor may be mounted on the second printed circuit board PCB2 at a finished product manufacturer (or a set manufacturer), or may be mounted on a separate circuit board electrically connected to the second printed circuit board PCB2.

Additionally, the timing controller 140 and the data driver 130 (or the data integrated circuit S-IC) may be integrally formed. A driving module in which the timing controller 140 and the data driver 130 are integrally formed may be named a timing controller embedded data driver (TED). The TED may be mounted on the first printed circuit board PCB1 or the second printed circuit board PCB2.

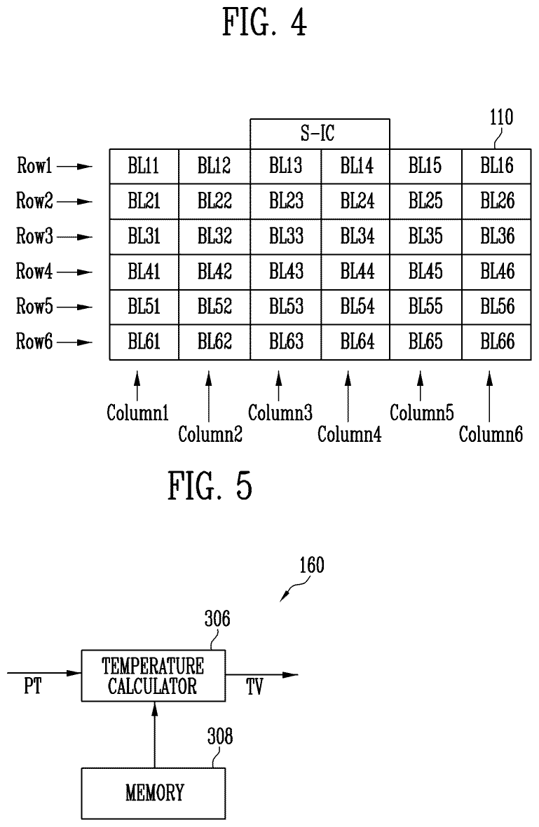

FIG. 3 is a block diagram illustrating a temperature determiner 160 according to an embodiment of the disclosure. FIG. 4 is a diagram illustrating an embodiment of blocks BL11 to BL66 included in the display unit 110. FIG. 4 shows one data integrated circuit S-IC and some blocks BL11 to BL66 corresponding thereto.

Referring to FIG. 3, the temperature determiner 160 according to an embodiment of the disclosure may include a voltage determiner 302, a temperature predictor 304, a temperature calculator 306, and a memory 308.

The voltage determiner 302 may change grayscale information of the input data Din into voltage information and generate voltage data VDin including the voltage information. For example, the voltage determiner 302 may be a look-up table that includes the voltage information corresponding to the grayscale information of the input data Din. The voltage data VDin generated in the voltage determiner 302 may be supplied to the temperature predictor 304.

The temperature predictor 304 may generate a temperature prediction value PT corresponding to a temperature of a driver using the voltage data VDin. For example, the driver may be set to the data integrated circuit S-IC, and the temperature predictor 304 may predict a temperature of the data integrated circuit S-IC using the voltage data VDin.

The voltage data VDin may correspond to a voltage (that is, the voltage of the data signal) to be supplied from the data integrated circuit S-IC to the display unit 110. Here, the temperature of the data integrated circuit S-IC may be set differently in response to the voltage to be supplied to the display unit 110 (that is, the voltage of the data signal). The temperature predictor 304 may determine the load of the data integrated circuit S-IC using the voltage data VDin, and may generate the temperature prediction value PT corresponding to the temperature of the data integrated circuit S-IC in correspondence with the load.

In an embodiment, the driver may be set to the timing controller 140, and the temperature predictor 304 may determine a temperature of the timing controller 140 using the voltage data VDin (and/or the input data Din). For example, the temperature predictor 304 may determine a load of the timing controller 140 using the voltage data VDin (and/or the input data Din), and may generate the temperature prediction value PT corresponding to the temperature of the timing controller 140 in correspondence with the load.

Position and size (or area) information of blocks BL11, BL12, BL13, BL14, BL15, BL16, BL21, BL22, BL23, BL24, BL25, BL26, BL31, BL32, BL33, BL34, BL35, BL36, BL41, BL42, BL43, BL44, BL45, BL46, BL51, BL52, BL53, BL54, BL55, BL56, BL61, BL62, BL63, BL64, BL65, and BL66 may be stored in the memory 308. Each of the blocks BL11 to BL66 may include two or more pixels PX. A look-up table and/or an algorithm (or a mathematical equation) may be stored in the memory 308 so that a temperature value TV may be calculated in the temperature calculator 306.

The temperature calculator 306 may generate the temperature value TV corresponding to a temperature of each of the blocks BL11 to BL66 using the temperature prediction value PT. The temperature value TV generated in the temperature calculator 306 may be provided to various drivers including the timing controller 140.

Referring to FIG. 4, the display unit 110 may be partitioned into the plurality of blocks BL11 to BL66. The display unit 110 may be divided in horizontal lines Row1, Row2, Row3, Row4, Row5, and Row6 and vertical lines Column1, Column2, Column3, Column4, Column5, and Column6 in correspondence with a disposition of the blocks BL11 to BL66.

Here, the horizontal line may mean a row direction in which the blocks BL11 to BL66 are disposed, and the vertical line may mean a column direction in which the blocks BL11 to BL66 are disposed.

For example, the blocks BL11, BL12, BL13, BL14, BL15, and BL16 may be disposed in the first horizontal line Row1, blocks BL21, BL22, BL23, BL24, BL25, and BL26 may be disposed in the second horizontal line Row2, the blocks BL31, BL32, BL33, BL34, BL35, and BL36 may be disposed in the third horizontal line Row3, blocks BL41, BL42, BL43, BL44, BL45, and BL46 may be disposed in the fourth horizontal line Row4, the blocks BL51, BL52, BL53, BL54, BL55, and BL56 may be disposed in the fifth horizontal line Row5, and the blocks BL61, BL62, BL63, BL64, BL65, and BL66 may be disposed in the sixth horizontal line Row6.

For example, the blocks BL11, BL21, BL31, BL41, BL51, and BL61 may be disposed in the first vertical line Column1, blocks BL12, BL22, BL32, BL42, BL52, and BL62 may be disposed in the second vertical line Column2, the blocks BL13, BL23, BL33, BL43, BL53, and BL63 may be disposed in the third vertical line Column3, blocks BL14, BL24, BL34, BL44, BL54, and BL64 may be disposed in the fourth vertical line Column4, blocks BL15, BL25, BL35, BL45, BL55, and BL65 may be disposed in the fifth vertical line Column5, and the blocks BL16, BL26, BL36, BL46, BL56, and BL66 may be disposed in the sixth vertical line Column6.

The area (or size) and position information of each of the blocks BL11 to BL66 may be stored in the memory 308. For example, the area of each of the blocks BL11 to BL66 may be set to be the same. The temperature calculator 306 may generate the temperature value TV of each of the blocks BL11 to BL66 in correspondence with the temperature prediction value PT.

FIG. 5 is a block diagram illustrating a temperature determiner 160 according to an embodiment of the disclosure. When describing FIG. 5, the same reference numerals are assigned to the same configurations as those of FIG. 3, and an overlapping description is omitted.

Referring to FIG. 5, the temperature determiner 160 according to an embodiment of the disclosure may include the temperature calculator 306 and the memory 308.

The temperature calculator 306 may receive the temperature prediction value PT from the outside. The temperature prediction value PT may include temperature information of at least one driver, and may be input to the temperature calculator 306 from the application processor, the timing controller 140, and/or the like. For example, the temperature of the driver corresponding to the input data Din may be measured in a process, and such information may be stored outside the temperature determiner 160 in advance. The timing controller 140, the application processor, and/or the like may generate the temperature prediction value PT of the drivers corresponding to the input data Din using the temperature information stored in advance.

The temperature calculator 306 may generate the temperature value TV corresponding to the temperature of each of the blocks BL11 to BL66 using the temperature prediction value PT. The temperature value TV generated in the temperature calculator 306 may be provided to various drivers including the timing controller 140.

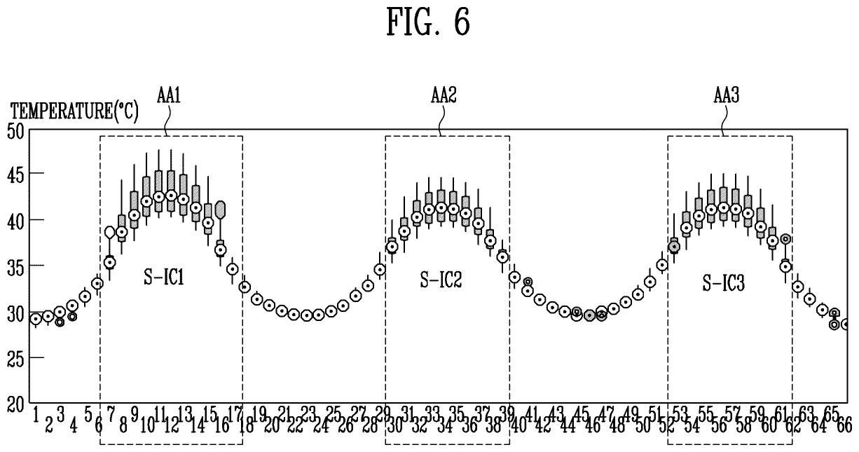

FIG. 6 is a box plot illustrating a temperature dispersion in the first horizontal line. In FIG. 6, three data integrated circuits S-IC1, S-IC2, S-IC3 are included, and the three data integrated circuits S-IC1, S-IC2, S-IC3 are positioned adjacent to the first horizontal line. In addition, each of the blocks BL11 to BL66 includes 32×32 pixels PX. Here, each of the pixels PX may include three sub-pixels of different colors. In FIG. 6, a Y-axis represents a temperature ° C., and an X-axis represents blocks positioned on the first horizontal line.

In FIG. 4, for convenience of description of the disclosure, the blocks BL13 and BL14 are shown disposed adjacent to the data integrated circuit S-IC. FIG. 6 is a simulation of a predetermined panel, and it may be understood that the blocks BL9, BL10, BL11, BL12, BL13, BL14, and the like are disposed adjacent to the data integrated circuit S-IC1.

Referring to FIG. 6, it may be seen that a temperature dispersion occurs greatly in the blocks positioned adjacent to the data integrated circuits S-IC1, S-IC2, and S-IC3, for example, a first area AA1, a second area AA2, and a third area AA3. In this case, when one temperature value TV is generated in each of the blocks positioned in the first area AA1, the second area AA2, and the third area AA3, an error between an actual temperature and the temperature value TV may occur.

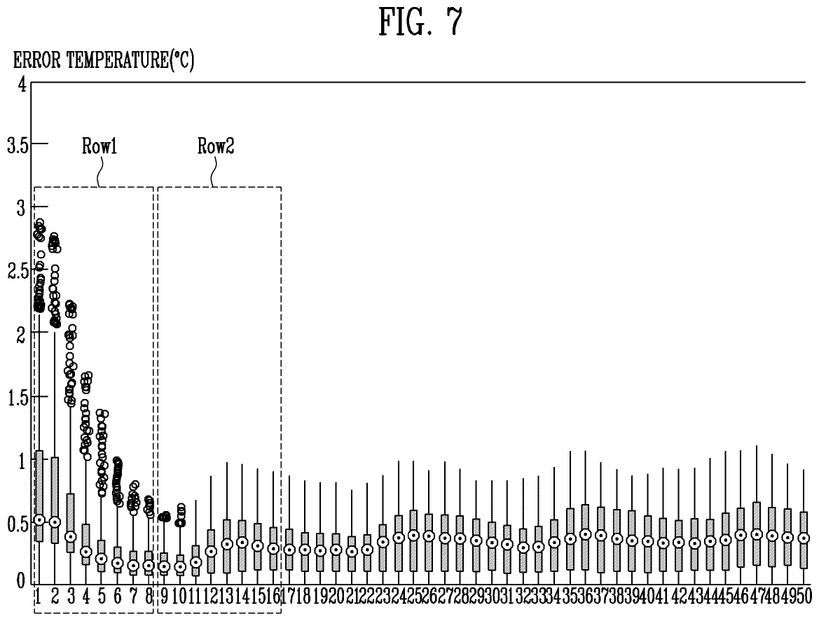

FIG. 7 is a box plot illustrating an error temperature between the temperature value generated in the temperature determiner and an actually measured temperature value. In FIG. 7, a Y-axis represents the error temperature. The error temperature represents an absolute temperature value obtained by subtracting an actual temperature value of the display unit 110 from the temperature value TV. Each of the blocks BL11 to BL66 includes 32×32 pixels PX, and in FIG. 7, an X-axis represents a case where blocks including 4×4 pixels PX are disposed in a vertical direction after interpolating the temperature value TV of each of the blocks BL11 to BL66 in a sub-block unit including 4×4 pixels.

In this case, blocks 1, 2, 3, 4, 5, 6, 7, and 8 written in the X-axis of FIG. 7 may correspond to the block (at least one of BL11 to BL16) positioned in the first horizontal line Row1 of FIG. 4, and blocks 9, 10, 11, 12, 13, 14, 15, and 16 may correspond to the block (at least one of BL21 to BL26) positioned in the second horizontal line Row2 of FIG. 4.

Referring to FIG. 7, the error temperature between the temperature value TV generated in the temperature determiner 160 and the actually measured temperature value occurs greatly in the blocks BL11 to BL16 positioned in the first horizontal line Row1. In other words, it may be seen that the error temperature between the temperature value TV generated in the temperature determiner 160 and the actually measured temperature value occurs greatly in the blocks adjacent to the driver. As described above, when the error temperature between the temperature value TV generated in the temperature determiner 160 and the actually measured temperature value increases, display quality of the display unit 110 may be deteriorated.

Regarding this, a method of minimizing the error temperature by reducing the area (or size) of the blocks BL11 to BL16 may be predicted. However, when the area (or size) of the blocks BL11 to BL16 is reduced, a capacity of the memory 308 may be increased, and thus practical application may be difficult. Therefore, in an embodiment of the disclosure, a method of minimizing an increase of the capacity of the memory 308 while minimizing the error temperature in the blocks adjacent to the driver is presented.

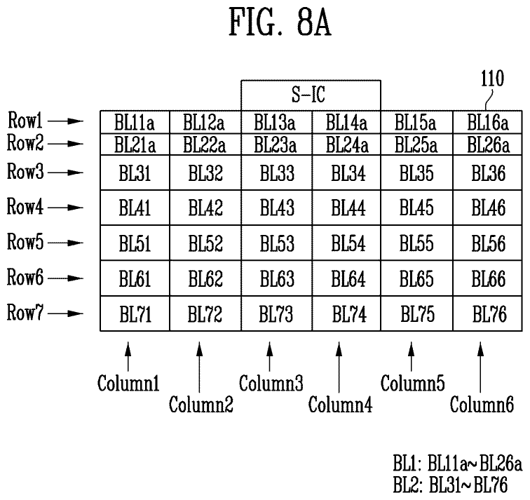

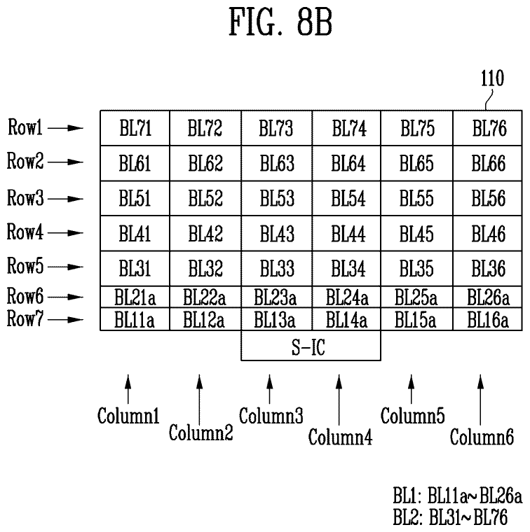

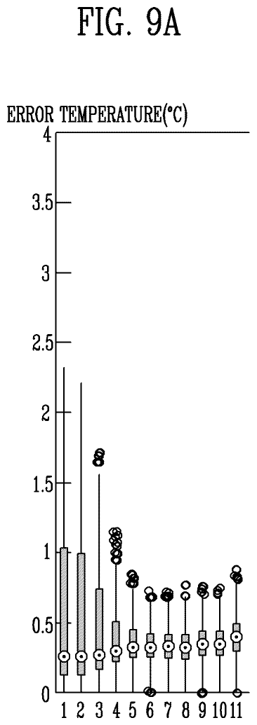

FIGS. 8A and 8B are diagrams illustrating an embodiment of blocks BL11a, BL12a, BL13a, BL14a, BL15a, BL16a, BL21a, BL22a, BL23a, BL24a, BL25a, BL26a, BL31 to BL66, BL71, BL72, BL73, BL74, BL75, and BL76 included in the display unit 110. In FIGS. 8A and 8B, the data integrated circuit S-IC is included as the driver, and the data integrated circuit S-IC may be disposed on an upper side or a lower side of a panel. FIGS. 8A and 8B show one data integrated circuit S-IC among the plurality of data integrated circuits S-IC included in the display unit 110 and the blocks BL11a, BL12a, BL13a, BL14a, BL15a, BL16a, BL21a, BL22a, BL23a, BL24a, BL25a, BL26a, BL31 to BL66, BL71, BL72, BL73, BL74, BL75, and BL76 corresponding to the data integrated circuit S-IC.

For convenience of description, in FIG. 8A, the blocks positioned in the first horizontal line Row1 are named BL11a, BL12a, . . . , and the like, and in FIG. 8B, the blocks positioned in the seventh horizontal line Row7 are named BL11a, BL12a, . . . , and the like. In this case, the names of each of the blocks, for example, BL11a, BL31, BL76, and the like are for distinguishing the block and may be unrelated to a position of the blocks.

Referring to FIGS. 8A and 8B, the display unit 110 may include the first block BL1 positioned adjacent to the driver (that is, the data integrated circuit S-IC) and the second block BL2 positioned spaced apart from the data integrated circuit S-IC. The first block BL1 may include the plurality of first sub-blocks BL11a to BL26a positioned adjacent to the data integrated circuit S-IC, and the second block BL2 may include the plurality of second sub-blocks BL31 to BL76 positioned spaced apart from the data integrated circuit S-IC. Each of the first sub-blocks BL11a to BL26a and the second sub-blocks BL31 to BL76 may include two or more pixels PX.

Each of the first sub-blocks BL11a to BL26a may have the area (or size) different from that of each of the second sub-blocks BL31 to BL76. For example, each of the first sub-blocks BL11a to BL26a may have the area less than that of each of the second sub-blocks BL31 to BL76. Here, the first block BL1 may be defined as a block including sub-blocks (for example, BL11a to BL26a) of the area less than that of the second block BL2.

The first block BL1 may be positioned adjacent to the data integrated circuit S-IC. For example, each of the first sub-blocks BL11a to BL26a included in the first block BL1 may be positioned in at least one horizontal line adjacent to the data integrated circuit S-IC.

For example, when the data integration circuit S-IC is disposed on an upper side of the display unit 110 (or the upper side of the panel) as shown in FIG. 8A, the first sub-blocks BL11a to BL26a may be positioned in at least one horizontal line (for example, the first horizontal line Row1 and the second horizontal line Row2) adjacent to the data integrated circuit S-IC. Here, the areas of each of the first sub-blocks BL11a to BL26a positioned in the same horizontal line (for example, the first horizontal line Row1 and/or the second horizontal line Row2) may be the same.

For example, when the data integration circuit S-IC is disposed on a lower side of the display unit 110 (or the lower side of the panel) as shown in FIG. 8B, the first sub-blocks BL11a to BL26a may be positioned in at least one horizontal line (for example, the sixth horizontal line Row6 and the seventh horizontal line Row7) adjacent to the data integrated circuit S-IC. Here, the areas of each of the first sub-blocks BL11a to BL26a positioned in the same horizontal line (for example, the sixth horizontal line Row6 and/or the seventh horizontal line Row7) may be the same.

In the above-described embodiment of the disclosure, the area of each of the first sub-blocks BL11a to BL26a adjacent to the data integrated circuit S-IC (that is, driver) is set to be less than the area of each of the second sub-blocks BL31 to BL76 spaced apart from the data integrated circuit S-IC. In this case, an area adjacent to the data integrated circuit S-IC may be subdivided, and thus accuracy of the temperature value TV modeled in the temperature determiner 160 may be improved. For example, the temperature determiner 160 may calculate the temperature value TV in a unit of the area of each of the first sub-blocks BL11a to BL26a and the second sub-blocks BL31 to BL76, and thus accuracy of the temperature value TV may be improved.

Additionally, position information and area (or size) information of each of the first sub-blocks BL11a to BL26a and the second sub-blocks BL31 to BL76 may be stored in the memory 308.

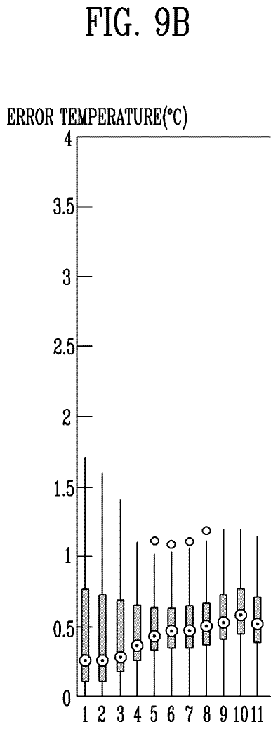

FIGS. 9A and 9B are box plots illustrating an error temperature between the temperature value generated in the temperature determiner and the actually measured temperature value when displaying a first image. The first image may display a black and white image in most of the area and may be an image including a graph of box and circular shapes. FIG. 9A illustrates a case where blocks include 32×32 pixels PX, and FIG. 9B illustrates a case where blocks positioned in the first horizontal line Row1 adjacent to the driver include 32×16 pixels PX, and blocks positioned in a remaining horizontal line include 32×32 pixels PX.

In FIGS. 9A and 9B, a Y axis represents the error temperature. In FIGS. 9A and 9B, an X-axis represents a case where the sub-blocks are disposed in the vertical line direction after interpolating the temperature value measured in each of the blocks in a sub-block unit of 4x4 pixels PX. In this case, the numbers 1, 2, 3, . . . of the X-axis may mean 4×4 blocks.

Referring to FIGS. 9A and 9B, when the blocks of the display unit 110 include only 32×32 pixels PX as shown in FIG. 9A, a max error temperature is set to approximately 2.4° C., and when the blocks positioned in an area adjacent to the driver include 32×16 pixels PX as shown in FIG. 9B, the max error temperature is set to approximately 1.7° C. That is, when the area of the blocks in the area adjacent to the driver is reduced as in an embodiment of the disclosure, the error temperature may be reduced. Additionally, as the area of the first sub-blocks BL11a to BL26a included in the first block BL1 is reduced, the error temperature may be reduced.

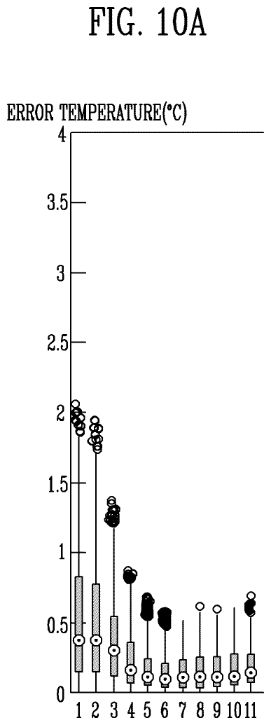

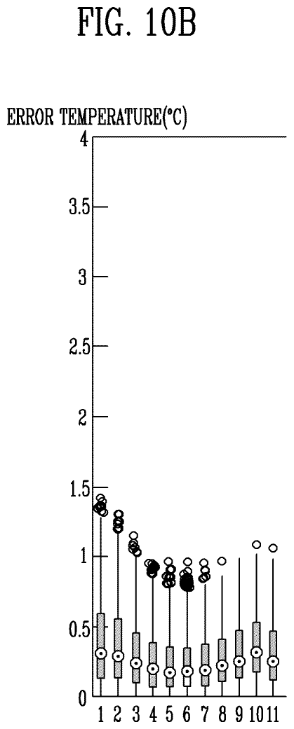

FIGS. 10A and 10B are box plots illustrating the error temperature between the temperature value generated in the temperature determiner and the actually measured temperature value when displaying a second image. The second image may display a color image in most of an area and may be an image including a graph in a quadrangle box shape. FIG. 10A illustrates a case where blocks include 32×32 pixels PX, and FIG. 10B illustrates a case where the blocks positioned in the first horizontal line Row1 adjacent to the driver include 32×16 pixels PX, and the blocks positioned in the remaining horizontal lines include 32×32 pixels PX.

In FIGS. 10A and 10B, a Y-axis represents the error temperature. In FIGS. 10A and 10B, an X-axis illustrates a case where the sub-blocks are disposed in the vertical line direction after interpolating the temperature value measured in each of the blocks in a sub-block unit of 4×4 pixels PX. In this case, the numbers 1, 2, 3, . . . of the X-axis may mean 4×4 blocks

Referring to FIGS. 10A and 10B, when the blocks of the display unit 110 include only 32×32 pixels PX as shown in FIG. 10A, a max error temperature is set to approximately 2.1° C., and when the blocks positioned in an area adjacent to the driver include 32×16 pixels PX as shown in FIG. 10B, the max error temperature is set to approximately 1.4° C. That is, when the first block BL1 of which the area is less than that of the second block BL2 is disposed in the area adjacent to the driver as in an embodiment of the disclosure, the error temperature may be reduced. Additionally, as the area of the first sub-blocks BL11a to BL26a included in the first block BL1 is reduced, the error temperature may be reduced.

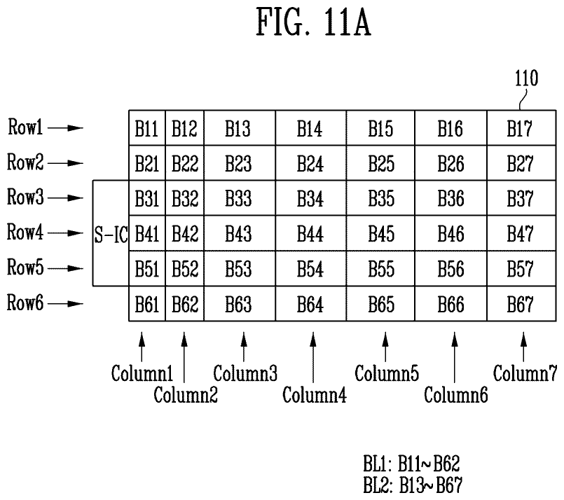

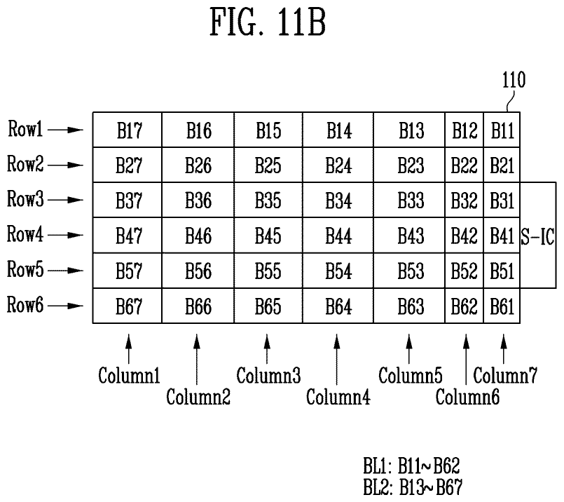

FIGS. 11A and 11B are diagrams illustrating an embodiment of blocks B11, B12, B13, B14, B15, B16, B17, B21, B22, B23, B24, B25, B26, B27, B31, B32, B33, B34, B35, B36, B37, B41, B42, B43, B44, B45, B46, B47, B51, B52, B53, B54, B55, B56, B57, B61, B62, B63, B64, B65, B66, B67 included in the display unit 110. In FIGS. 11A and 11B, the data integrated circuit S-IC is included as the driver, and the data integrated circuit S-IC may be disposed on the left side or the right side of the panel.

FIGS. 11A and 11B show one data integrated circuit S-IC among the plurality of data integrated circuits S-IC included in the display unit 110 and the blocks B11, B12, B13, B14, B15, B16, B17, B21, B22, B23, B24, B25, B26, B27, B31, B32, B33, B34, B35, B36, B37, B41, B42, B43, B44, B45, B46, B47, B51, B52, B53, B54, B55, B56, B57, B61, B62, B63, B64, B65, B66, B67 corresponding to the data integrated circuit S-IC.

For convenience of description, in FIG. 11A, the blocks positioned in the first vertical line Column1 are named B11, B12, . . . , and the like, and in FIG. 11B, the blocks positioned in the seventh vertical line Column7 are named B11, B12, . . . and the like. In this case, the names of each of the blocks, for example, B11, B35, B67, and the like are for distinguishing the blocks and may be unrelated to a position of the blocks.

Referring to FIGS. 11A and 11B, the display unit 110 may include a first block BL1 (for example, B11, B21, B31, B41, B51, B61, B12, B22, B32, B42, B52, and B62) positioned adjacent to the driver (for example, the data integrated circuit S-IC), and a second block BL2 (for example, B13, B23, B33, B43, B53, B63, B14, B24, B34, B44, B54, B64, B15, B25, B35, B45, B55, B65, B16, B26, B36, B46, B56, B66, B17, B27, B37, B47, B57, and B67) positioned spaced apart from the data integrated circuit S-IC.

The first block BL1 may include the plurality of first sub-blocks B11 to B62 positioned adjacent to the data integrated circuit S-IC, and the second block BL2 may include the plurality of second sub-blocks B13 to B67 positioned spaced apart from the data integrated circuit S-IC. The first sub-blocks B11 to B62 may be positioned in at least one vertical line adjacent to the data integrated circuit S-IC. Each of the first sub-blocks B11 to B62 and the second sub-blocks B13 to B67 may include two or more pixels PX.

Each of the first sub-blocks B11 to B62 may have the area (or size) different from that of each of the second sub-blocks B13 to B67. For example, each of the first sub-blocks B11 to B62 may have the area less than that each of the second sub-blocks B13 to B67.

For example, when the data integration circuit S-IC is disposed on a left side of the display unit 110 (or the left side of the panel) as shown in FIG. 11A, the first sub-blocks B11 to B62 may be disposed in at least one vertical line (for example, the first vertical line Column1 and the second vertical line Column2) adjacent to the data integrated circuit S-IC. Here, areas of each of the first sub-blocks B11 to B62 positioned in the same vertical line (for example, the first vertical line Column1 and/or the second vertical line Column2) may be the same.

For example, when the data integrated circuit S-IC is disposed on a right side of the display unit 110 (or the right side of the panel) as shown in FIG. 11B, the first sub-blocks B11 to B62 may be placed in at least one vertical line (for example, the sixth vertical line Column6 and the seventh vertical line Column7) adjacent to the data integrated circuit S-IC. Here, areas of each of the first sub-blocks B11 to B62 positioned in the same vertical line (for example, the sixth vertical line Column6 and/or the seventh vertical line Column7) may be the same.

In the above-described embodiment of the disclosure, the area of each of the first sub-blocks B11 to B62 adjacent to the data integrated circuit S-IC (that is, the driver) is set to be less than that of each of the second sub-blocks B13 to B67 spaced apart from the data integrated circuit S-IC. In this case, the area adjacent to the data integrated circuit S-IC may be subdivided, and thus accuracy of the temperature value TV modeled in the temperature determiner 160 may be improved. For example, the temperature determiner 160 may calculate the temperature value TV in a unit of the area of each of the first sub-blocks B11 to B62 and the second sub-blocks B13 to B67, and thus accuracy of the temperature value TV may be improved.

Additionally, position information and area (or size) information of each of the first sub-blocks B11 to B62 and the second sub-blocks B13 to B67 may be stored in the memory 308.

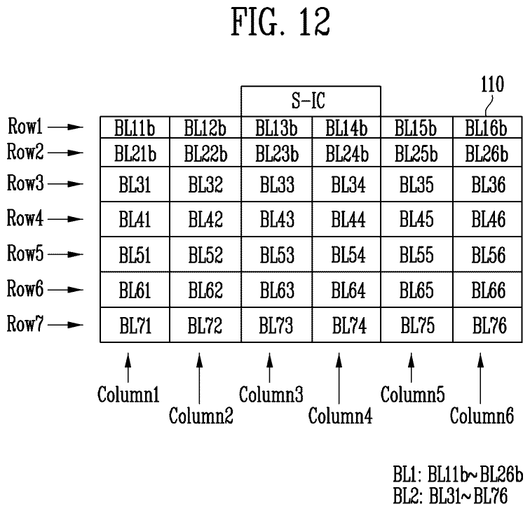

FIG. 12 is a diagram illustrating an embodiment of blocks BL1, BL2 included in the display unit 110. In FIG. 12, the data integrated circuit S-IC may be included as the driver, and the data integrated circuit S-IC may be disposed on the upper side of the panel (or the display unit 110). However, the data integrated circuit S-IC may be disposed on the lower side, the left side, or the right side of the panel as described with reference to FIGS. 8B, 11A, and 11B.

Referring to FIG. 12, the display unit 110 may include the first block BL1 (for example, BL11b, BL12b, BL13b, BL14b, BL15b, BL16b, BL21b, BL22b, BL23b, BL24b, BL25b, and BL26b) positioned adjacent to the driver (that is, the data integrated circuit S-IC) and the second block BL2 (for example, BL31 to BL76) positioned spaced apart from the data integrated circuit S-IC.

The first block BL1 may include the plurality of first sub-blocks BL11b to BL26b positioned adjacent to the data integrated circuit S-IC, and the second block BL2 may include the plurality of second sub-blocks BL31 to BL76 positioned to be spaced apart from the data integrated circuit S-IC. Each of the first sub-blocks BL11b to BL26b and the second sub-blocks BL31 to BL76 may include two or more pixels PX.

Each of the first sub-blocks BL11b to BL26b may have the area (or size) different from that of each of the second sub-blocks BL31 to BL76. For example, each of the first sub-blocks BL11b to BL26b may have the area less than that of each of the second sub-blocks BL31 to BL76.

The first block BL1 may be positioned adjacent to the data integrated circuit S-IC. For example, each of the first sub-blocks BL11b to BL26b included in the first block BL1 may be positioned in at least one horizontal line adjacent to the data integrated circuit S-IC. For example, the first sub-blocks BL11b to BL26b may be positioned in the first horizontal line Row1 and the second horizontal line Row2 to be adjacent to the data integrated circuit S-IC. Here, the area of the first sub-blocks BL11b to BL26b may be set to be increased as a distance from the data integrated circuit S-IC increases in the vertical direction.

For example, each of the first sub-blocks BL11b to BL16b positioned in the first horizontal line Row1 may be set to the first area, and each of the first sub-blocks BL21b to BL26b positioned in the second horizontal line Row2 may be set to the second area. Here, the second area may be greater than the first area. When the areas of the first sub-blocks BL11b to BL16b and BL21b to BL26b are set differently based on the distance from the data integrated circuit S-IC, the capacity of the memory 308 included in the temperature determiner 160 may be reduced, and accuracy of the temperature value TV generated in the temperature determiner 160 may be improved.

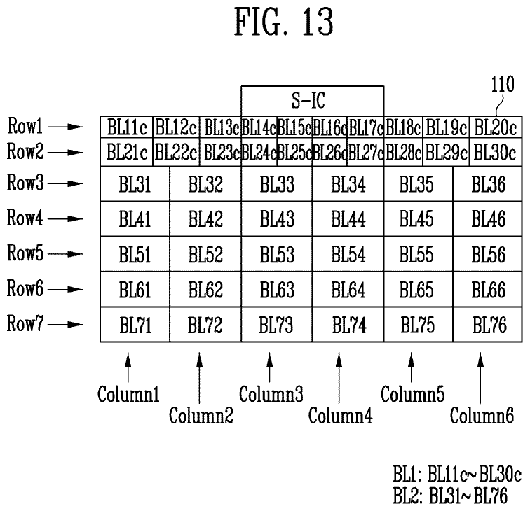

FIG. 13 is a diagram illustrating an embodiment of the blocks BL1, BL2 included in the display unit 110. In FIG. 13, the data integrated circuit S-IC may be included as the driver, and the data integrated circuit S-IC may be disposed on the upper side of the panel (or the display unit 110). However, the data integrated circuit S-IC may be disposed on the lower side, the left side, or the right side of the panel as described with reference to FIGS. 8B, 11A, and 11B.

Referring to FIG. 13, the display unit 110 may include the first block BL1 (for example, BL11c, BL12c, BL13c, BL14c, BL15c, BL16c, BL17c, BL18c, BL19c, BL20c, BL21c, BL22c, BL23c, BL24c, BL25c, BL26c, BL27c, BL28c, BL29c, and BL30c) positioned adjacent to the driver (that is, the data integrated circuit S-IC) and the second block BL2 (for example, BL31 to BL76) positioned spaced apart from the data integrated circuit S-IC.

Each of the first sub-blocks BL11c to BL30c included in the first block BL1 may have the area (or size) different from that of each of the second sub-blocks BL31 to BL76 included in the second block BL2. For example, each of the first sub-blocks BL11c to BL30c may have the area less than that of each of the second sub-blocks BL31 to BL76. Each of the first sub-blocks BL11c to BL30c and the second sub-blocks BL31 to BL76 may include two or more pixels PX.

The first block BL1 may be positioned adjacent to the data integrated circuit S-IC. For example, the first block BL1 may be positioned in at least one horizontal line adjacent to the data integrated circuit S-IC. For example, the first sub-blocks BL11c to BL30c may be positioned in the first horizontal line Row1 and the second horizontal line Row2 to be adjacent to the data integrated circuit S-IC. Here, the area of the first sub-blocks BL11c to BL30c may be set to be increased as a distance from the data integrated circuit S-IC increases in the horizontal direction and the vertical direction, that is, the distance from the data integrated circuit S-IC increases.

For example, the first sub-block BL14c positioned at a first distance from the data integrated circuit S-IC in the first horizontal line Row1 may have the area less than that of the first sub-block BL11c positioned at a second distance greater than the first distance. For example, the first sub-block BL14c positioned in the first horizontal line Row1 may have the area less than that of the first sub-block BL24c positioned in the second horizontal line Row2.

When the area of the first sub-blocks BL11c to BL30c is set differently based on the distance from the data integrated circuit S-IC, the capacity of the memory 308 included in the temperature determiner 160 may be reduced, and accuracy of the temperature value TV generated in the temperature determiner 160 may be improved.

Additionally, position information and area (or size) information of each of the first sub-blocks BL11c to BL30c and the second sub-blocks BL31 to BL76 may be stored in the memory 308.

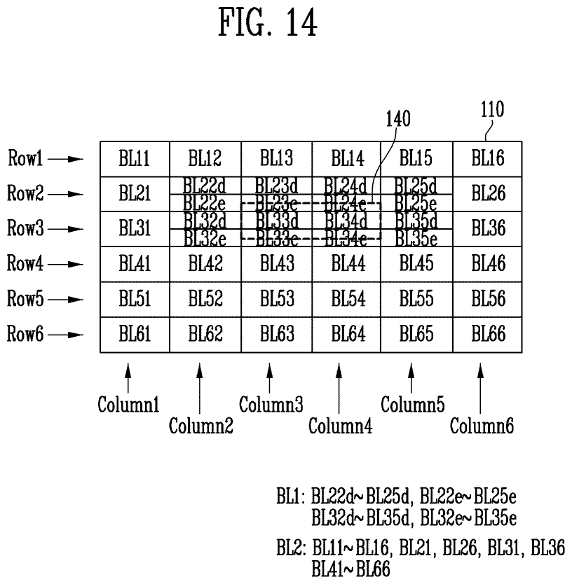

FIG. 14 is a diagram illustrating an embodiment of the blocks BL1, BL2 included in the display unit 110. In FIG. 14, the timing controller 140 is shown as the driver, and the timing controller 140 may be disposed to overlap the panel (or the display unit 110). However, in addition to the timing controller 140, various drivers including the data integrated circuit S-IC may be disposed to overlap the panel (or the display unit 110).

Referring to FIG. 14, when the timing controller 140 overlaps the display unit 110, the first block BL1 (for example, BL22d, BL23d, BL24d, BL25d, BL22e, BL23e, BL24e, BL25e, BL32d, BL33d, BL34d, BL35d, BL32e, BL33e, BL34e, and BL35e) may be disposed in an area where the display unit 110 and the timing controller 140 overlap and an area adjacent thereto, and the second block BL2 (for example, BL11 to BL16, BL21, BL26, BL31, BL36, and BL41 to BL66) may be disposed spaced apart from the timing controller 140.

The first block BL1 may include the first sub-blocks BL22d to BL25d, BL22e to BL25e, BL32d to BL35d, and BL32e to BL35e, and at least one of the first sub-blocks BL22d to BL25d, BL22e to BL25e, BL32d to BL35d, and BL32e to BL35e may be positioned at an intersection of at least one horizontal line and a vertical line overlapping the timing controller 140. Each of the first sub-blocks BL22d to BL25d, BL22e to BL25e, BL32d to BL35d, BL32e to BL35e may have the area less than that of each of the second sub-blocks BL11 to BL16, BL21, BL26, BL31, BL36, and BL41 to BL66 included in the second block BL2. Each of the first sub-blocks BL22d to BL25d, BL22e to BL25e, BL32d to BL35d, and BL32e to BL35e and the second sub-blocks BL11 to BL16, BL21, BL26, BL31, BL36, and BL41 to BL66 may include two or more pixels PX.

Each of the first sub-blocks BL22d to BL25d, BL22e to BL25e, BL32d to BL35d, and BL32e to BL35e may have the same area, but an embodiment of the disclosure is not limited thereto. For example, the area of each of the first sub-blocks BL22d to BL25d, BL22e to BL25e, BL32d to BL35d, and BL32e to BL35e may gradually increase as a distance from the timing controller 140 (or the driver) increases.

When the first block BL1 is disposed adjacent to (or overlapping) the timing controller 140, the capacity of the memory 308 included in the temperature determiner 160 may be reduced and accuracy of the temperature value TV generated in the temperature determiner 160 may be improved.

Additionally, position information and area (or size) information of each of the first sub-blocks BL22d to BL25d, BL22e to BL25e, BL32d to BL35d, and BL32e to BL35e and the second sub-blocks BL11 to BL16, BL21, BL26, BL31, BL36, and BL41 to BL66 may be stored in the memory 308.

FIG. 15 is a diagram illustrating an embodiment of the pixel PXij shown in FIG. 2.

Referring to FIG. 15, the pixel PXij includes transistors T11, T12, T13, T14, T15, T16, and T17, a storage capacitor Cst, and a light emitting element LD.

Hereinafter, a circuit configured of a P-type transistor is described as an example. However, those skilled in the art will be able to design a circuit configured of an N-type transistor by differentiating a polarity of a voltage applied to a gate terminal. Similarly, those skilled in the art will be able to design a circuit configured of a combination of a P-type transistor and an N-type transistor. The transistor may be configured in various forms such as a thin film transistor (TFT), a field effect transistor (FET), and a bipolar junction transistor (BJT).

The eleventh transistor T11 may have a gate electrode connected to a first node N1, a first electrode connected to a second node N2, and a second electrode connected to a third node N3. The eleventh transistor T11 may be referred to as a driving transistor.

The twelfth transistor T12 may have a gate electrode connected to a scan line Si1, a first electrode connected to a data line Dj, and a second electrode connected to the second node N2. The thirteenth transistor T13 may have a gate electrode connected to a scan line Si2, a first electrode connected to the first node N1, and a second electrode connected to the third node N3.

The fourteenth transistor T14 may have a gate electrode connected to a scan line Si3, a first electrode connected to the first node N1, and a second electrode connected to an initialization line INTL. The fifteenth transistor T15 may have a gate electrode connected to an i-th emission control line ELi, a first electrode connected to a first power line PL1, and a second electrode connected to the second node N2. In an embodiment, the gate electrode of the fifteenth transistor T15 may be connected to an emission control line different from an emission control line connected to a gate electrode of the sixteenth transistor T16.

The sixteenth transistor T16 may have a gate electrode connected to the i-th emission control line ELi, a first electrode connected to the third node N3, and a second electrode connected to an anode of the light emitting element LD. The seventeenth transistor T17 may have a gate electrode connected to the scan line Si4, a first electrode connected to the initialization line INTL, and a second electrode connected to the anode of the light emitting device LD.

A first electrode of the storage capacitor Cst may be connected to the first power line PL1 and a second electrode may be connected to the first node N1.

The anode of the light emitting element LD may be connected to the second electrode of the sixteenth transistor T16 and a cathode may be connected to a second power line PL2. The light emitting element LD may be a light emitting diode. The light emitting element LD may be configured of an organic light emitting element (organic light emitting diode), an inorganic light emitting element (inorganic light emitting diode), a quantum dot/well light emitting element (quantum dot/well light emitting diode), or the like. The light emitting element LD may emit light in one color among a first color, a second color, and a third color. In addition, although only one light emitting element LD is provided in each pixel in the present embodiment, a plurality of light emitting elements may be provided in each pixel in an embodiment. At this time, the plurality of light emitting elements may be connected in series, parallel, series-parallel, or the like.

A voltage of first driving power VDD may be applied to the first power line PL1, a voltage of second driving power VSS may be applied to the second power line PL2, and a voltage of initialization power may be applied to the initialization line INTL. For example, the voltage of the first driving power VDD may be greater than the voltage of the second driving power VSS. For example, the voltage of the initialization power may be equal to or greater than the voltage of the second driving power VSS. For example, the voltage of the initialization power may correspond to the smallest size of data voltage among data voltages that may be provided. In another example, a voltage size of the initialization power may be less than sizes of the data voltages that may be provided.

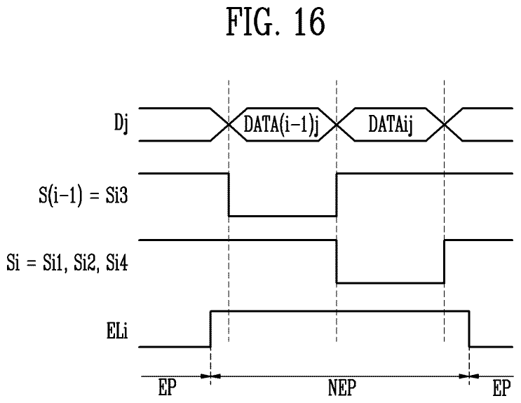

FIG. 16 is a diagram illustrating a method of driving the pixel PXij shown in FIG. 15.

Hereinafter, for convenience of description, it is assumed that the scan lines Si1, Si2, and Si4 are i-th scan lines Si and the scan line Si3 is an (i−1)-th scan line S(i−1). However, a connection relationship of the scan lines Si1, Si2, Si3, and Si4 may be various according to embodiments. For example, the scan line Si4 may be the (i−1)-th scan line or an (i+1)-th scan line.

First, an emission control signal of a turn-off level (logic high level) is applied to the i-th emission control line ELi, a data signal DATA(i−1)j for an (i−1)-th pixel is applied to the data line Dj, and a scan signal of a turn-on level (logic low level) is applied to the scan line Si3. The high/low of the logic level may vary according to whether a transistor is a P-type or an N-type.

At this time, since a scan signal of a turn-off level is applied to the scan lines Si1 and Si2, the twelfth transistor T12 is turned off and the data signal DATA(i−1)j is prevented from being input to the pixel PXij.

At this time, since the fourteenth transistor T14 is turned on, the first node N1 is connected to the initialization line INTL, and a voltage of the first node N1 is initialized. Since the emission control signal of the turn-off level is applied to the emission control line Ei, the transistors T15 and T16 are turned off, and unnecessary light emission of the light emitting element LD according to a process of applying the voltage of the initialization power is prevented.

A data signal DATAij for the i-th pixel PXij is applied to the data line Dj, and the scan signal of the turn-on level is applied to the scan lines Si1 and Si2. Accordingly, the transistors T12, T11, and T13 are turned on, and the data line Dj and the first node N1 are electrically connected with each other. Therefore, a compensation voltage obtained by subtracting a threshold voltage of the eleventh transistor T11 from the data signal DATAij is applied to the second electrode of the storage capacitor Cst (that is, the first node N1), and the storage capacitor Cst maintains a voltage corresponding to a difference between the first power driving power VDD and the compensation voltage. Such a period may be referred to as a threshold voltage compensation period or a data writing period.

In addition, when the scan line Si4 is the i-th scan line, since the seventeenth transistor T17 is turned on, the anode of the light emitting element LD and the initialization line INTL are connected with each other, and the light emitting element LD is initialized to a charge amount corresponding to a voltage difference between the voltage of the initialization power and the second driving power VSS.

Thereafter, as the emission control signal of the turn-on level is applied to the i-th emission control line ELi, the transistors T15 and T16 may be turned on. Therefore, a driving current path connecting the first power line PL1, the fifteenth transistor T15, the eleventh transistor T11, the sixteenth transistor T16, the light emitting element LD, and the second power line PL2 is formed.

A driving current amount flowing to the first electrode and the second electrode of the eleventh transistor T11 is adjusted according to the voltage maintained in the storage capacitor Cst. The light emitting element LD emits light with a luminance corresponding to the driving current amount. The light emitting element LD emits light until the emission control signal of the turn-off level is applied to the emission control line Ei.

When the emission control signal is the turn-on level, pixels receiving the corresponding emission control signal may be in a display state. Therefore, a period in which the emission control signal is the turn-on level may be referred to as an emission period EP (or an emission allowable period). In addition, when the emission control signal is the turn-off level, pixels receiving the corresponding emission control signal may be in a non-display state. Therefore, a period in which the emission control signal is the turn-off level may be referred to as a non-emission period NEP (or an emission disallowable period).

The non-emission period NEP described with reference to FIG. 16 is for preventing the pixel PXij from emitting light with an undesired luminance during the initialization period and the data writing period.

One or more non-emission periods NEP may be additionally provided while the data signal written to the pixel PXij is maintained (for example, one frame period). This may be for effectively expressing a low grayscale by reducing the emission period EP of the pixel PXij, or for smoothly blurring a motion of an image.

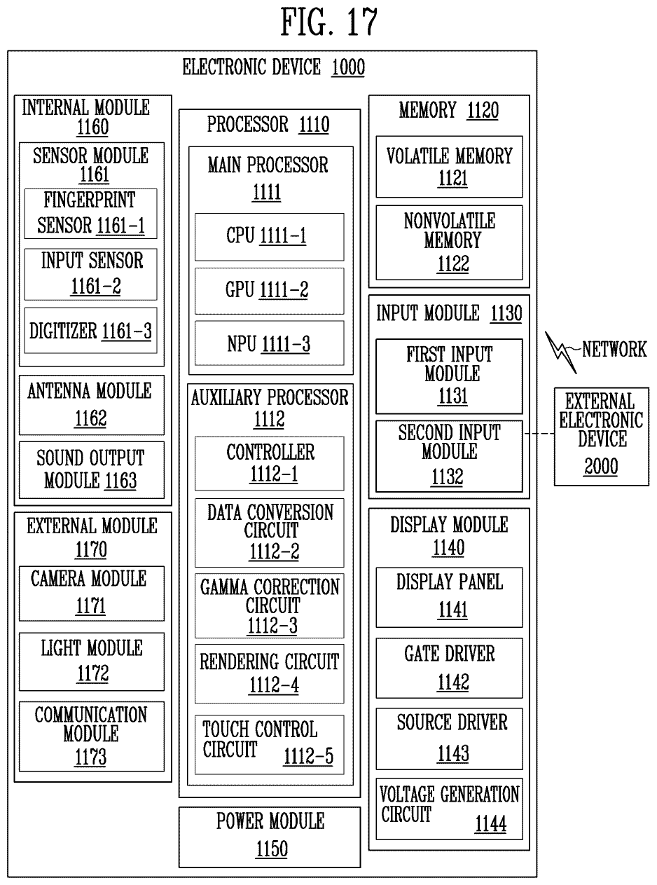

FIG. 17 is a diagram illustrating an electronic device 1000 according to an embodiment of the disclosure.

Referring to FIG. 17, the electronic device 1000 outputs various pieces of information through a display module 1140. When a processor 1110 executes an application stored in a memory 1120, the display module 1140 provides application information to a user through a display panel 1141.

The processor 1110 obtains an external input through an input module 1130 or a sensor module 1161 and executes an application corresponding to the external input. For example, when the user selects a camera icon (or a camera application icon) displayed on the display panel 1141, the processor 1110 obtains a user input through an input sensor 1161-2 and activates a camera module 1171. The processor 1110 transmits image data corresponding to a captured image obtained through the camera module 1171 to the display module 1140. The display module 1140 may display an image corresponding to the captured image through the display panel 1141.

As another example, when personal information authentication is executed in the display module 1140, a fingerprint sensor 1161-1 obtains input fingerprint information as input data. The processor 1110 compares input data obtained through the fingerprint sensor 1161-1 with authentication data stored in the memory 1120 and executes an application according to a comparison result. The display module 1140 may display information executed according to a logic of the application through the display panel 1141. The fingerprint sensor 1161-1 may be disposed to obtain the fingerprint information from the entire area of the display module 1140 (or the display panel 1141).

As still another example, when a music streaming icon displayed on the display module 1140 is selected, the processor 1110 obtains a user input through the input sensor 1161-2 and activates a music streaming application stored in the memory 1120. When a music execution command is input in the music streaming application, the processor 1110 activates a sound output module 1163 to provide sound information corresponding to the music execution command to the user.

In the above, an operation of the electronic device 1000 is briefly described. Hereinafter, a configuration of the electronic device 1000 is described in detail. Some of configurations of the electronic device 1000 to be described later may be integrated and provided as one configuration, and one configuration may be separated into two or more configurations and provided.

The electronic device 1000 may communicate with an external electronic device 2000 through a network (for example, a short-range wireless communication network or a long-range wireless communication network). According to an embodiment, the electronic device 1000 may include the processor 1110, the memory 1120, the input module 1130, the display module 1140, a power module 1150, an internal module 1160, and an external module 1170. According to an embodiment, in the electronic device 1000, at least one of the above-described components may be omitted or one or more other components may be added. According to an embodiment, some of the above-described components (for example, the sensor module 1161, an antenna module 1162, or the sound output module 1163) may be integrated into another component (for example, the display module 1140).

The processor 1110 may execute software to control at least another component (for example, a hardware or software component) of the electronic device 1000 connected to the processor 1110, and perform various data processing or operations. According to an embodiment, as at least a portion of the data processing or operation, the processor 1110 may store a command or data received from another component (for example, the input module 1130, the sensor module 1161, or a communication module 1173) in a volatile memory 1121, process the command or the data stored in the volatile memory 1121, and store result data in a nonvolatile memory 1122.

The processor 1110 may include a main processor 1111 and an auxiliary processor 1112. The main processor 1111 may include a central processing unit (CPU) 1111-1. The main processor 1111 may further include any one or more of a graphic processing unit (GPU) 1111-2, a communication processor (CP), and an image signal processor (ISP). The main processor 1111 may further include a neural processing unit (NPU) 1111-3. The NPU 1111-3 is a processor specialized in processing an artificial intelligence model, and the artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN), a deep Q-network, or a combination of two or more of the above, but is not limited to the above-described example. Additionally or alternatively, the artificial intelligence model may include a software structure in addition to a hardware structure. At least two of the above-described processing units and processors may be implemented as one integrated configuration (for example, a single chip), or each may be implemented as an independent configuration (for example, a plurality of chips).

The auxiliary processor 1112 may include a controller 1112-1. The controller 1112-1 may include an interface conversion circuit and a timing control circuit. For example, the controller 1112-1 may include the timing controller 140 shown in FIG. 1. For example, the controller 1112-1 may include the temperature determiner 160 shown in FIG. 1.

The controller 1112-1 receives an image signal from the main processor 1111, converts a data format of the image signal to correspond to an interface specification with the display module 1140, and outputs image data. The controller 1112-1 may output various control signals required for driving the display module 1140.

The auxiliary processor 1112 may further include a data conversion circuit 1112-2, a gamma correction circuit 1112-3, a rendering circuit 1112-4, a touch control circuit 1112-5, and the like. The data conversion circuit 1112-2 may receive the image data from the controller 1112-1, compensate the image data to display an image with a desired luminance according to a characteristic of the electronic device 1000, a setting of the user, or the like, or convert the image data for reduction of power consumption, afterimage compensation, or the like.

The gamma correction circuit 1112-3 may convert the image data, a gamma reference voltage, or the like so that the image displayed on the electronic device 1000 has a desired gamma characteristic. The rendering circuit 1112-4 may receive the image data from the controller 1112-1 and render the image data in consideration of a pixel disposition or the like of the display panel 1141 applied to the electronic device 1000.

The touch control circuit 1112-5 may supply a touch signal to the input sensor 1161-2 and receive a sensing signal from the input sensor 1161-2 in response to the touch signal.

At least one of the data conversion circuit 1112-2, the gamma correction circuit 1112-3, the rendering circuit 1112-4, and the touch control circuit 1112-5 may be integrated into another component (for example, the main processor 1111 or the controller 1112-1). At least one of the data conversion circuit 1112-2, the gamma correction circuit 1112-3, and the rendering circuit 1112-4 may be integrated into a source driver 1143 to be described later.

The memory 1120 may store various data used by at least one component (for example, the processor 1110 or the sensor module 1161) of the electronic device 1000, and input data or output data for a command related thereto. In addition, various setting data corresponding to setting of the user may be stored in the memory 1120. The memory 1120 may include at least one of the volatile memory 1121 and the nonvolatile memory 1122.

The input module 1130 may receive a command or data to be used by a component (for example, the processor 1110, the sensor module 1161, or the sound output module 1163) of the electronic device 1000 from an outside (for example, the user or the external electronic device 2000) of the electronic device 1000.

The input module 1130 may include a first input module 1131 to which a command or data is input from the user and a second input module 1132 to which a command or data is input from the external electronic device 2000. The first input module 1131 may include a microphone, a mouse, a keyboard, a key (for example, a button), or a pen (for example, a passive pen or an active pen). The second input module 1132 may support a designated protocol capable of connecting to the external electronic device 2000 by wire or wirelessly. According to an embodiment, the second input module 1132 may include a high definition multimedia interface (HDMI), a universal serial bus (USB) interface, an SD card interface, or an audio interface. The second input module 1132 may include a connector capable of physically connecting to the external electronic device 2000, for example, an HDMI connector, a USB connector, an SD card connector, or an audio connector (for example, a headphone connector).

The display module 1140 visually provides information to the user. The display module 1140 may include the display panel 1141, a gate driver 1142, the source driver 1143, and a voltage generation circuit 1144. The display module 1140 may further include a window, a chassis, and a bracket for protecting the display panel 1141. The display module 1140 may include at least a partial configuration of the display device 100 shown in FIG. 2.

The display panel 1141 (or a display) may include a liquid crystal display panel, an organic light emitting display panel, or an inorganic light emitting display panel, and a type of the display panel 1141 is not particularly limited. The display panel 1141 may be a rigid type or a flexible type that may be rolled or folded. The display module 1140 may further include a supporter, a bracket, a heat dissipation member, or the like that supports the display panel 1141. The display panel 1141 may include the display unit 110 shown in FIG. 2.

The gate driver 1142 may be mounted on the display panel 1141 as a driving chip. In addition, the gate driver 1142 may be integrated in the display panel 1141. For example, the gate driver 1142 may include an amorphous silicon TFT gate driver circuit (ASG), a low temperature polycrystalline silicon (LTPS) TFT gate driver circuit, or an oxide semiconductor TFT gate driver circuit (OSG) built in the display panel 1141. The gate driver 1142 receives a control signal from the controller 1112-1 and outputs scan signals to the display panel 1141 in response to the control signal. The gate driver 1142 may include the scan driver 120 shown in FIG. 2.

The display module 1140 may further include an emission driver. The emission driver outputs an emission control signal to the display panel 1141 in response to the control signal received from the controller 1112-1. The emission driver may be formed separately from the gate driver 1142 or may be integrated into the gate driver 1142. The emission driver may include the emission driver 150 shown in FIG. 2.

The source driver 1143 receives a control signal from the controller 1112-1, converts image data into an analog voltage (for example, a data signal) in response to the control signal, and outputs the data signals to the display panel 1141. The source driver 1143 may include the data driver 140 shown in FIG. 1.

The source driver 1143 may be integrated into another component (for example, the controller 1112-1). A function of the interface conversion circuit and the timing control circuit of the controller 1112-1 described above may be integrated into the source driver 1143. The voltage generation circuit 1144 may output various voltages necessary to drive the display panel 1141.

In an embodiment, the source driver 1143 may convert data corresponding to red (R), green (G), and blue (B) included in the image data received from the processor into a red data signal (or data voltage), a green data signal, and the blue data signal, and may provide the red data signal, the green data signal, and the blue data signal to the plurality of pixel columns included in the display panel 1141 during one horizontal period.

The power module 1150 supplies power to a component of the electronic device 1000. The power module 1150 may include a battery that charges a power voltage. The battery may include a non-rechargeable primary cell, and a rechargeable secondary cell or fuel cell. The power module 1150 may include a power management integrated circuit (PMIC). The PMIC supplies optimized power to each of the above-described module and a module to be described later. The power module 1150 may include a wireless power transmission/reception member electrically connected to the battery. The wireless power transmission/reception member may include a plurality of antenna radiators of a coil form. In an embodiment, at least a partial configuration of the power module 1150 and the voltage generation circuit 1144 may be integrated into one and provided. As an example, the voltage generation circuit 1144 may be included in the power module 1150.

The electronic device 1000 may further include the internal module 1160 and the external module 1170. The internal module 1160 may include the sensor module 1161, the antenna module 1162, and the sound output module 1163. The external module 1170 may include the camera module 1171, a light module 1172, and the communication module 1173.

The sensor module 1161 may sense an input by a body of the user or an input by a pen among the first input module 1131, and may generate an electrical signal or a data value corresponding to the input. The sensor module 1161 may include at least one of the fingerprint sensor 1161-1, the input sensor 1161-2, and a digitizer 1161-3.

The fingerprint sensor 1161-1 may generate a data value corresponding to a fingerprint of the user.

The input sensor 1161-2 may generate a data value corresponding to coordinate information of the input by the body of the user or the pen. The input sensor 1161-2 generates a capacitance change amount by the input as the data value. The input sensor 1161-2 may sense an input by the passive pen or may transmit/receive data to and from the active pen.

The input sensor 1161-2 may measure a biometric signal such as blood pressure, water, or body fat. For example, when the user touches a sensor layer or a sensing panel with a body part and does not move during a certain time, the input sensor 1161-2 may sense the biometric signal based on a change of an electric field by the body part and output information desired by the user to the display module 1140.

The digitizer 1161-3 may generate a data value corresponding to coordinate information of the input by the pen. The digitizer 1161-3 generates an electromagnetic change amount by the input as the data value. The digitizer 1161-3 may sense the input by the passive pen or may transmit/receive data to and from the active pen.

At least one of the fingerprint sensor 1161-1, the input sensor 1161-2, and the digitizer 1161-3 may be implemented as the sensor layer formed on the display panel 1141 through a continuous process. At least one of the fingerprint sensor 1161-1, the input sensor 1161-2, and the digitizer 1161-3 may be disposed above the display panel 1141, and any one of the fingerprint sensor 1161-1, the input sensor 1161-2, and the digitizer 1161-3, for example, the digitizer 1161-3 may be disposed below the display panel 1141.

At least two of the fingerprint sensor 1161-1, the input sensor 1161-2, and the digitizer 1161-3 may be formed to be integrated into one sensing panel through the same process. When at least two of the fingerprint sensor 1161-1, the input sensor 1161-2, and the digitizer 1161-3 are integrated into one sensing panel, the sensing panel may be disposed between the display panel 1141 and a window disposed above the display panel 1141. According to an embodiment, the sensing panel may be disposed on the window, and a position of the sensing panel is not particularly limited.

At least one of the fingerprint sensor 1161-1, the input sensor 1161-2, and the digitizer 1161-3 may be embedded in the display panel 1141. That is, at least one of the fingerprint sensor 1161-1, the input sensor 1161-2, and the digitizer 1161-3 may be simultaneously formed through a process of forming elements (for example, a light emitting element, a transistor, and the like) included in the display panel 1141. In addition, the sensor module 1161 may generate an electrical signal or a data value corresponding to an internal state or an external state of the electronic device 1000. The sensor module 1161 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas for transmitting a signal or power to an outside or receiving a signal or power from an outside. According to an embodiment, the communication module 1173 may transmit a signal to an external electronic device or receive a signal from an external electronic device through an antenna suitable for a communication method. An antenna pattern of the antenna module 1162 may be integrated into one configuration (for example, the display panel 1141) of the display module 1140 or the input sensor 1161-2.

The sound output module 1163 is a device for outputting a sound signal to an outside of the electronic device 1000, and may include, for example, a speaker used for general purposes such as multimedia playback or recording playback, and a receiver used exclusively for receiving a call. According to an embodiment, the receiver may be formed integrally with or separately from the speaker. A sound output pattern of the sound output module 1163 may be integrated into the display module 1140.

The camera module 1171 may capture a still image and a moving image. According to an embodiment, the camera module 1171 may include one or more lenses, an image sensor, or an image signal processor. The camera module 1171 may further include an infrared camera capable of measuring presence or absence of the user, a position of the user, a gaze of the user, and the like.

The light module 1172 may provide light. The light module 1172 may include a light emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000 and communication performance through the established communication channel. The communication module 1173 may include any one or both of a wireless communication module such as a cellular communication module, a short-range wireless communication module, or a global navigation satellite system (GNSS) communication module, and a wired communication module such as a local area network (LAN) communication module or a power line communication module. The communication module 1173 may communicate with the external electronic device 2000 through a short-range communication network such as Bluetooth, WiFi direct, or infrared data association (IrDA), or a long-range communication network such as a cellular network, the Internet, or a computer network (for example, LAN or WAN). The above-described various types of communication modules 1173 may be implemented as a single chip or as separate chips.

The input module 1130, the sensor module 1161, the camera module 1171, and the like may be used to control an operation of the display module 1140 in conjunction with the processor 1110.

The processor 1110 outputs a command or data to the display module 1140, the sound output module 1163, the camera module 1171, or the light module 1172 based on input data received from the input module 1130. For example, the processor 1110 may generate image data in response to the input data applied through a mouse, an active pen, or the like and output the image data to the display module 1140, or generate command data in response to the input data and output the command data to the camera module 1171 or the light module 1172. When the input data is not received from the input module 1130, the processor 1110 may convert an operation mode of the electronic device 1000 to a low power mode or a sleep mode to reduce power consumed in the electronic device 1000.

The processor 1110 outputs a command or data to the display module 1140, the sound output module 1163, the camera module 1171, or the light module 1172 based on sensing data received from the sensor module 1161. For example, the processor 1110 may compare authentication data applied by the fingerprint sensor 1161-1 with authentication data stored in the memory 1120 and execute an application according to a comparison result. The processor 1110 may execute the command based on sensing data sensed by the input sensor 1161-2 or the digitizer 1161-3 or output corresponding image data to the display module 1140. When the sensor module 1161 includes a temperature sensor, the processor 1110 may receive temperature data for a measured temperature from the sensor module 1161 and further perform luminance correction or the like on the image data based on the temperature data.

The processor 1110 may receive measurement data for the presence of the user, the position of the user, the gaze of the user, and the like, from the camera module 1171. The processor 1110 may further perform luminance correction or the like on the image data based on the measurement data. For example, the processor 1110 determining the presence or absence of the user through an input from the camera module 1171 may output image data of which a luminance is corrected through the data conversion circuit 1112-2 or the gamma correction circuit 1112-3 to the display module 1140.

Some of the above-described components may be connected to each other through a communication method between peripheral devices, for example, a bus, general purpose input/output (GPIO), a serial peripheral interface (SPI), a mobile industry processor interface (MIPI), or an ultra path interconnect (UPI) link to exchange a signal (for example, a command or data) with each other. The processor 1110 may communicate with the display module 1140 through a mutually agreed interface, for example, may use any one of the above-described communication methods, and is not limited to the above-described communication method.

Although the above has been described with reference to the embodiments of the disclosure, those skilled in the art will understand that the disclosure may be variously modified and changed without departing from the spirit and scope of the disclosure described in the claims.

What is claimed is:

1. A display device comprising:
a display unit including pixels connected to data lines and scan lines and including a plurality of blocks partitioned to include at least two or more of the pixels;
at least one driver for driving the display unit; and
a temperature determiner for predicting a temperature of the display unit in a unit of the blocks,
wherein the blocks include a first block including first sub-blocks positioned adjacent to the driver, and a second block including second sub-blocks positioned spaced apart from the driver, and an area of each of the first sub-blocks and an area of each of the second sub-blocks are different.

2. The display device according to claim 1, wherein the area of each of the first sub-blocks is less than the area of each of the second sub-blocks.

3. The display device according to claim 2, wherein the area of the first sub-blocks gradually increases as a distance from the driver increases.

4. The display device according to claim 2, wherein the display unit is divided in a plurality of horizontal lines and a plurality of vertical lines in correspondence with a disposition of the first sub-blocks and the second sub-blocks.

5. The display device according to claim 4, wherein an area of the first sub-blocks positioned in a same horizontal line or a same vertical line has a same area.

6. The display device according to claim 5, wherein the area of the first sub-block gradually increases as a distance from the driver increases.

7. The display device according to claim 4, wherein the driver is disposed above or under the display unit, and the first sub-blocks are positioned in at least one horizontal line adjacent to the driver.

8. The display device according to claim 4, wherein the driver is disposed on a left side or a right side of the display unit, and the first sub-blocks are positioned in at least one vertical line adjacent to the driver.

9. The display device according to claim 4, wherein the driver overlaps the display unit, and the first sub-blocks are positioned at an intersection of at least one horizontal line and at least one vertical line overlapping the driver.

10. The display device according to claim 9, wherein the plurality of first sub-blocks are positioned adjacent to the driver, and the area of the first sub-blocks is the same.

11. The display device according to claim 9, wherein the plurality of first sub-blocks are positioned adjacent to the driver, and the area of the first sub-blocks gradually increases as a distance from the driver increases.

12. The display device according to claim 1, further comprising:
at least one data integrated circuit for driving the data lines;
a scan driver for driving the scan lines; and
a timing controller that controls the data integrated circuit and the scan driver, and includes the temperature determiner.

13. The display device according to claim 12, wherein the driver includes at least one of the data integrated circuit, the scan driver, and the timing controller.

14. The display device according to claim 1, wherein the temperature determiner comprises:
a temperature calculator for generating a temperature value by calculating a temperature of the first sub-blocks and the second sub-blocks included in the display unit in response to a temperature prediction value of the driver; and
a memory for providing position information and area information of the first sub-blocks and the second sub-blocks to the temperature calculator.

15. The display device according to claim 14, wherein the temperature determiner further comprises:
a voltage determiner for generating voltage data including voltage information corresponding to a grayscale of input data; and
a temperature predictor for generating the temperature prediction value using the voltage data.

16. A method of driving a display device, the method comprising:
dividing a display unit into a plurality of blocks to determine a temperature of the display unit;
determining a temperature of the blocks in response to input data; and
displaying an image corresponding to the input data on the display unit using at least one driver,
wherein the blocks include at least one first sub-block positioned adjacent to the driver and at least one second sub-block positioned spaced apart from the driver, and an area of the first sub-block and an area of the second sub-block are different.

17. The method according to claim 16, wherein the area of the first sub-block is less than the area of the second sub-block.

18. The method according to claim 17, wherein the blocks include a plurality of first sub-blocks, and the area of the first sub-blocks gradually increases as a distance from the driver increases.

19. An electronic device comprising:
a display module including a display panel for displaying an image and at least one driver for driving the display panel; and
a processor for controlling the display module,
wherein the display panel is divided into a plurality of blocks to determine a temperature, and an area of a first sub-block of the blocks positioned adjacent to the driver is different from an area of a second sub-block of the blocks positioned spaced apart from the driver.

20. The electronic device according to claim 19, wherein the area of the first sub-block is less than the area of the second sub-block.
